(19) United States
(12) Patent Application Publication
(10) Pub. No.: US 2025/0317977 A1
(43) Pub. Date: Oct. 9, 2025

(54) TECHNIQUES FOR PHYSICAL RANDOM ACCESS CHANNEL CONFIGURATION UNDER SYNCHRONIZATION SIGNAL BLOCK ADAPTATION IN TIME DOMAIN

(71) Applicant: QUALCOMM Incorporated, San Diego, CA (US)

(72) Inventors: Ahmed Attia ABOTABL, San Diego, CA (US); Diana MAAMARI, San Diego, CA (US); Hung Dinh LY, San Diego, CA (US)

(21) Appl. No.: 18/627,611

(22) Filed: Apr. 5, 2024

(51) Int. Cl. H04W 74/0833; H04W 48/08

(52) U.S. Cl. CPC H04W 74/0833; H04W 48/08

(57) ABSTRACT

Various aspects of the present disclosure generally relate to wireless communication. In some aspects, a user equipment (UE) may receive an indication associated with a change to a synchronization signal block (SSB) periodicity. The UE may determine one or more valid physical random access channel (PRACH) occasions based at least in part on the change to the SSB periodicity. The UE may mapping at least one SSB index to the one or more valid PRACH occasions. Numerous other aspects are described.

### FIELD OF THE DISCLOSURE

Aspects of the present disclosure generally relate to wireless communication and specifically relate to techniques, apparatuses, and methods associated with a physical random access channel configuration under synchronization signal block adaptation in a time domain.

### DESCRIPTION OF RELATED ART

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to a method of wireless communication performed by a user equipment (UE). The method may include receiving an indication associated with a change to a synchronization signal block (SSB) periodicity. The method may include determining one or more valid physical random access channel (PRACH) occasions based at least in part on the change to the SSB periodicity. The method may include mapping at least one SSB index to the one or more valid PRACH occasions.

Some aspects described herein relate to a UE for wireless communication. The UE may include one or more memories and one or more processors coupled to the one or more memories. The one or more processors may be configured to receive an indication associated with a change to an SSB periodicity. The one or more processors may be configured to determine one or more valid PRACH occasions based at least in part on the change to the SSB periodicity. The one or more processors may be configured to mapping at least one SSB index to the one or more valid PRACH occasions.

Some aspects described herein relate to a non-transitory computer-readable medium that stores a set of instructions for wireless communication by a UE. The set of instructions, when executed by one or more processors of the UE, may cause the UE to receive an indication associated with a change to an SSB periodicity. The set of instructions, when executed by one or more processors of the UE, may cause the UE to determine one or more valid PRACH occasions based at least in part on the change to the SSB periodicity. The set of instructions, when executed by one or more processors of the UE, may cause the UE to mapping at least one SSB index to the one or more valid PRACH occasions.

Some aspects described herein relate to an apparatus for wireless communication. The apparatus may include means for receiving an indication associated with a change to an SSB periodicity. The apparatus may include means for determining one or more valid PRACH occasions based at least in part on the change to the SSB periodicity. The apparatus may include mapping at least one SSB index to the one or more valid PRACH occasions.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a synchronization signal hierarchy, in accordance with the present disclosure.

FIG. 5 is a diagram illustrating examples of validation rules associated with a physical random access channel (PRACH) occasion, in accordance with the present disclosure.

FIG. 6 is a diagram illustrating an example of synchronization signal block (SSB) adaptation in a time domain, in accordance with the present disclosure.

FIGS. 7A-7C are diagrams illustrating examples associated with a PRACH configuration under SSB adaptation in a time domain, in accordance with the present disclosure.

FIG. 8 is a flowchart illustrating an example process performed, for example, by a UE in accordance with the present disclosure.

FIG. 9 is a diagram of an example apparatus for wireless communication in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Network energy savings (NES) and/or network energy efficiency measures are expected to have increased importance in wireless network operations for various reasons, such as climate change mitigation, environmental sustainability, and/or network cost reduction, among other examples. For example, although 5G New Radio (NR) generally offers a significant energy efficiency improvement per gigabyte over previous generations (e.g., long term evolution (LTE)), some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and most of the energy consumption and/or energy costs are associated with a radio access network (RAN), with data centers and fiber transport accounting for smaller shares. Accordingly, measures to increase network energy savings and/or improve network energy efficiency are factors that may drive adoption and/or expansion of wireless networks.

One technique to increase energy efficiency in a RAN is to enable dynamic or semi-static adaptation for a synchronization signal block (SSB) in a time domain (e.g., adapting an SSB periodicity). For example, as described herein, a network node may periodically transmit an SSB that carries a primary synchronization signal (PSS), a secondary synchronization signal (SSS), and/or a physical broadcast channel (PBCH) and to support initial access, cell search, cell measurement, cell selection or reselection, cell acquisition, camping, time and frequency synchronization, beam management, and/or beam selection, among other examples. Typically, the network node transmits the SSB following a periodic schedule where the SSB is transmitted one or more times, and often beamswept in multiple beam directions, in each SSB period or SSB burst. Therefore, one way to reduce power consumption in a RAN is to adapt the SSB periodicity such that the SSB is transmitted less frequently by a network node operating in an NES mode (or NES state) or more frequently during periods of high demand. However, dynamically or semi-statically adapting the SSB periodicity (e.g., rather than updating the SSB periodicity in a system information block (SIB)) poses challenges, such as potentially causing a valid physical random access channel (PRACH) occasion to become invalid and/or causing an invalid PRACH occasion to become valid.

For example, a PRACH occasion, also known as a random access channel (RACH) occasion or RO, generally includes resources in a time domain and a frequency domain in which a user equipment (UE) can transmit a PRACH preamble to initiate a RACH procedure. Furthermore, a UE may determine an SSB-RO mapping, where one or more SSB indexes are each mapped to a respective set of one or more valid PRACH occasions. For example, a PRACH occasion is generally considered valid when one or more validation conditions are satisfied, where the validation conditions may include that the PRACH occasion does not precede an SSB in a PRACH slot and/or that the PRACH occasion starts at least a threshold number of symbols after a last SSB symbol. Accordingly, in some cases, a valid PRACH occasion that does not precede an SSB in a PRACH slot and starts at least the threshold number of symbols after a last SSB symbol may become invalid due to a decrease in an SSB periodicity (e.g., resulting in SSBs being transmitted more frequently) resulting in the PRACH occasion preceding an SSB in a PRACH slot and/or starting fewer than the threshold number of symbols after a last SSB symbol. Alternatively, an invalid PRACH occasion that precedes an SSB in a PRACH slot and/or starts fewer than the threshold number of symbols after a last SSB symbol may become valid due to an increase in an SSB periodicity (e.g., resulting in SSBs being transmitted less frequently) resulting in the PRACH occasion no longer preceding an SSB in a PRACH slot and/or starting at least the threshold number of symbols after a last SSB symbol. In such cases, increasing or decreasing the SSB periodicity may impact which PRACH occasions are considered valid or invalid, which may detrimentally impact a UE by impacting an SSB-RO mapping that the UE uses to determine when to transmit a PRACH preamble to initiate a RACH procedure.

Various aspects relate generally to a PRACH configuration under SSB adaptation in a time domain. Some aspects more specifically relate to a UE receiving, from a network node, an indication of a change to an SSB periodicity, where the change may increase an SSB periodicity such that SSBs are transmitted less frequently or decrease an SSB periodicity such that SSBs are transmitted more frequently. Accordingly, some aspects described herein relate to techniques to determine a validity for one or more PRACH occasions when the change to the SSB periodicity resulting in one or more valid PRACH occasions becoming invalid and/or one or more invalid PRACH occasions becoming valid. For example, when a valid PRACH occasion fails to satisfy one or more validation rules related to an SSB timing after the change to the SSB periodicity, the PRACH occasion may remain valid for SSB-RO mapping purposes only (e.g., a UE does not use the PRACH occasion to transmit a PRACH preamble). In this way, the change to the validity of the PRACH occasion does not change the SSB-RO mapping, and legacy operation is not disrupted because the PRACH occasion is not used for RACH transmission. Similarly, when an invalid PRACH occasion satisfies the one or more validation rules related to an SSB timing after the change to the SSB periodicity, the PRACH occasion may remain invalid, which also does not change the SSB-RO mapping or disrupt legacy RACH operation. In such cases, when the change to the SSB periodicity is reflected in a SIB, such as SIB1, the UE may then follow the one or more validation rules to determine whether PRACH occasions are valid or invalid. Alternatively, in some aspects, the UE may follow the one or more validation rules to determine whether PRACH occasions are valid or invalid when the indication of the change to the SSB periodicity is indicated, where the validation rules may apply to SSBs associated with the change to the SSB periodicity in addition to SSB indexes indicated in a SIB and/or a serving cell configuration.

Multiple-access radio access technologies (RATs) have been adopted in various telecommunication standards to provide common protocols that enable wireless communication devices to communicate on a municipal, enterprise, national, regional, or global level. For example, 5G NR is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

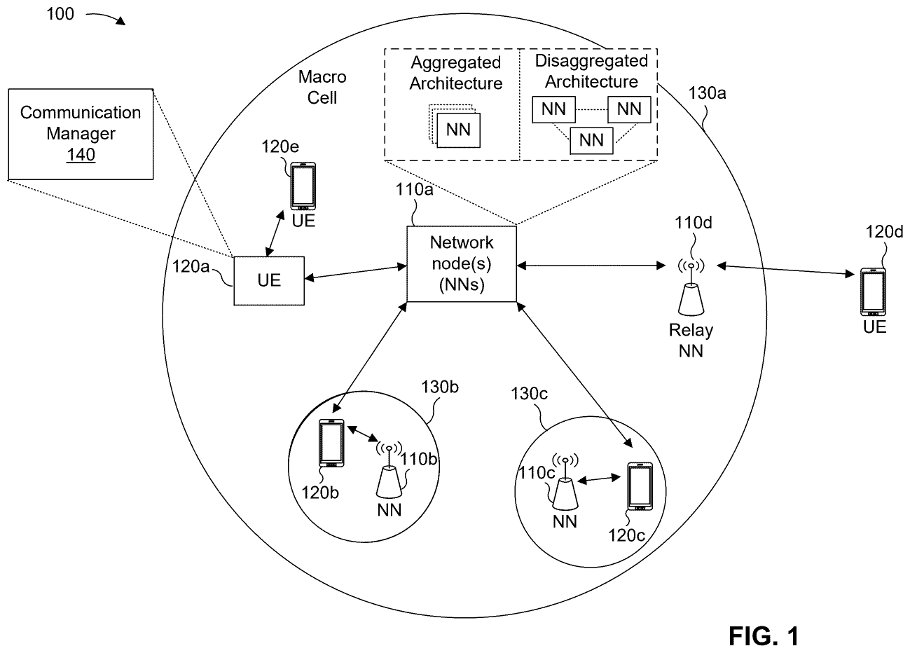

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, or channels. For example, devices of the wireless communication network 100 may communicate using one or more operating bands. In some aspects, multiple wireless networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a RAN.

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, PRACH extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, enhanced mobile broadband (eMBB), and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an indication associated with a change to an SSB periodicity; determine one or more valid PRACH occasions based at least in part on the change to the SSB periodicity; and mapping at least one SSB index to the one or more valid PRACH occasions. Additionally, or alternatively, the communication manager 140 may perform one or more other operations described herein.

As indicated above, FIG. 1 is provided as an example. Other examples may differ from what is described with regard to FIG. 1.

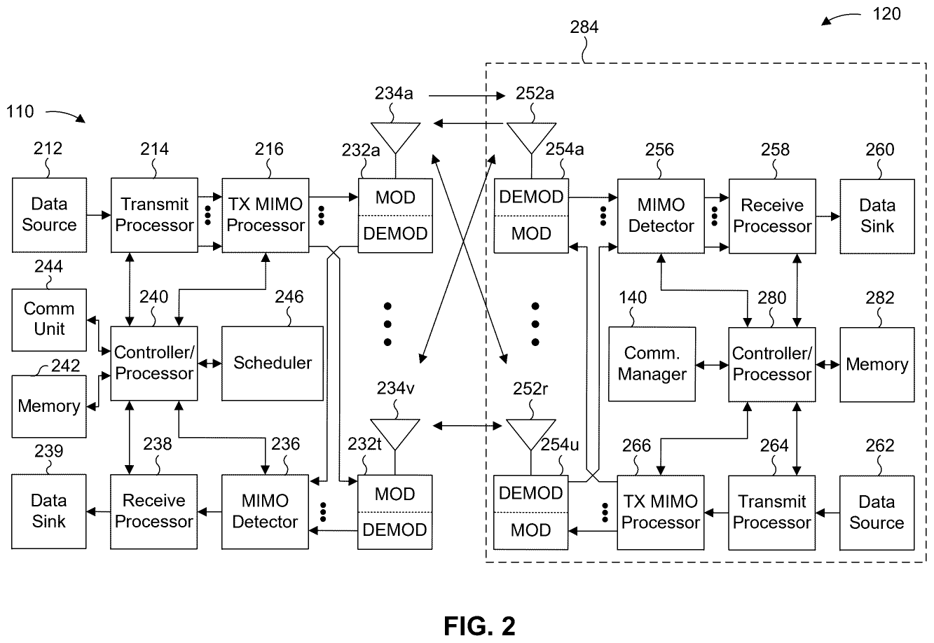

FIG. 2 is a diagram illustrating an example network node 110 in communication with an example UE 120 in a wireless network.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, and/or a scheduler 246, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a PSS or an SSS).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

In some aspects, the controller/processor 280 may be a component of a processing system. A processing system may generally be a system or a series of machines or components that receives inputs and processes the inputs to produce a set of outputs (which may be passed to other systems or components of, for example, the UE 120). For example, a processing system of the UE 120 may be a system that includes the various other components or subcomponents of the UE 120.

The processing system of the UE 120 may interface with one or more other components of the UE 120, may process information received from one or more other components (such as inputs or signals), or may output information to one or more other components. For example, a chip or modem of the UE 120 may include a processing system, a first interface to receive or obtain information, and a second interface to output, transmit, or provide information. In some examples, the first interface may be an interface between the processing system of the chip or modem and a receiver, such that the UE 120 may receive information or signal inputs, and the information may be passed to the processing system. In some examples, the second interface may be an interface between the processing system of the chip or modem and a transmitter, such that the UE 120 may transmit information output from the chip or modem. A person having ordinary skill in the art will readily recognize that the second interface also may obtain or receive information or signal inputs, and the first interface also may output, transmit, or provide information.

In some aspects, the controller/processor 240 may be a component of a processing system. A processing system may generally be a system or a series of machines or components that receives inputs and processes the inputs to produce a set of outputs (which may be passed to other systems or components of, for example, the network node 110). For example, a processing system of the network node 110 may be a system that includes the various other components or subcomponents of the network node 110.

The processing system of the network node 110 may interface with one or more other components of the network node 110, may process information received from one or more other components (such as inputs or signals), or may output information to one or more other components. For example, a chip or modem of the network node 110 may include a processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. A person having ordinary skill in the art will readily recognize that the second interface also may obtain or receive information or signal inputs, and the first interface also may output, transmit, or provide information.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

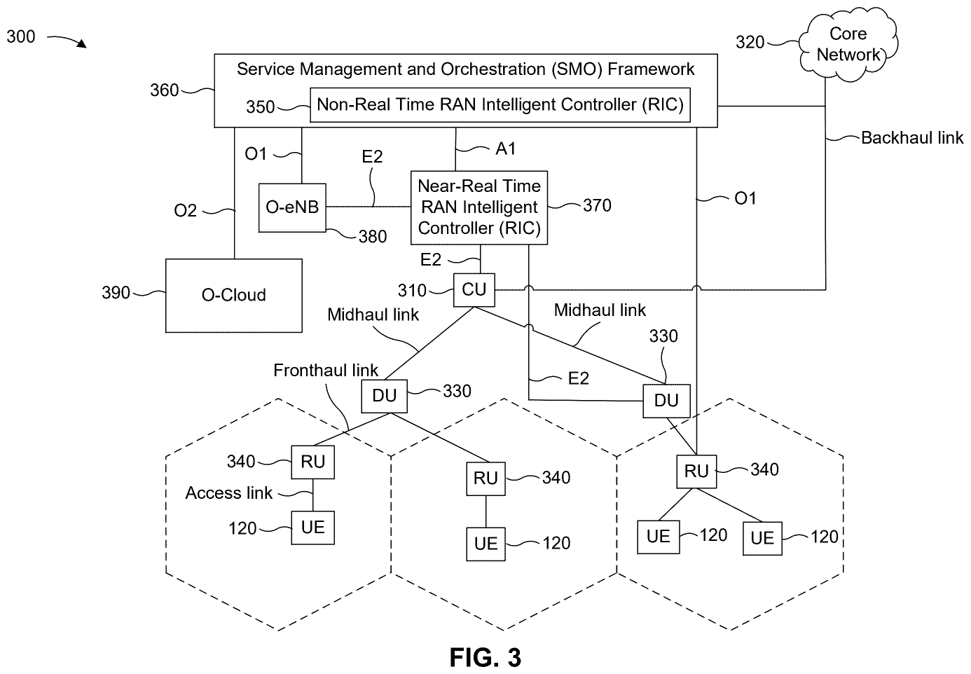

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

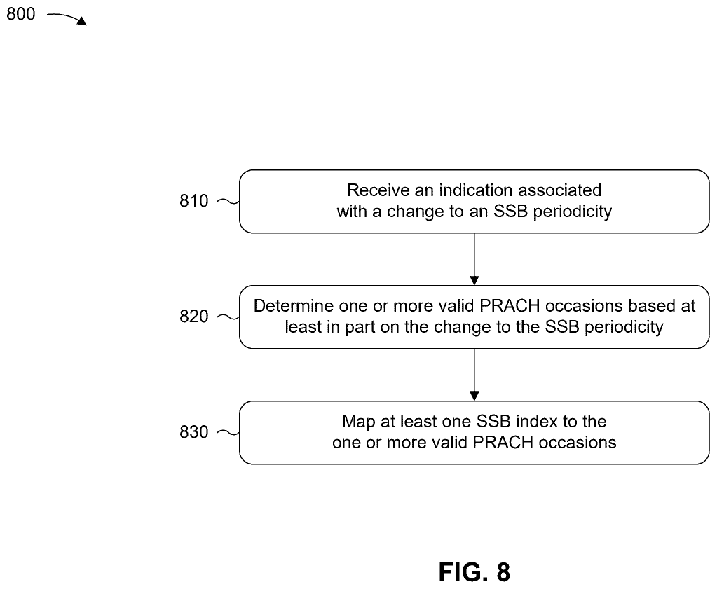

The network node 110, the controller/processor 240 of the network node 110, the UE 120, the controller/processor 280 of the UE 120, the CU 310, the DU 330, the RU 340, or any other component(s) of FIGS. 1, 2, or 3 may implement one or more techniques or perform one or more operations associated with a PRACH configuration under SSB adaptation in a time domain, as described in more detail elsewhere herein. For example, the controller/processor 240 of the network node 110, the controller/processor 280 of the UE 120, any other component(s) (or combinations of components) of FIG. 2, the CU 310, the DU 330, or the RU 340 may perform or direct operations of, for example, process 800 of FIG. 8 or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8 or other processes as described herein. In some examples, executing instructions may include running the instructions, converting the instructions, compiling the instructions, and/or interpreting the instructions, among other examples.

In some aspects, the UE 120 includes means for receiving an indication associated with a change to an SSB periodicity; means for determining one or more valid PRACH occasions based at least in part on the change to the SSB periodicity; and/or mapping at least one SSB index to the one or more valid PRACH occasions. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

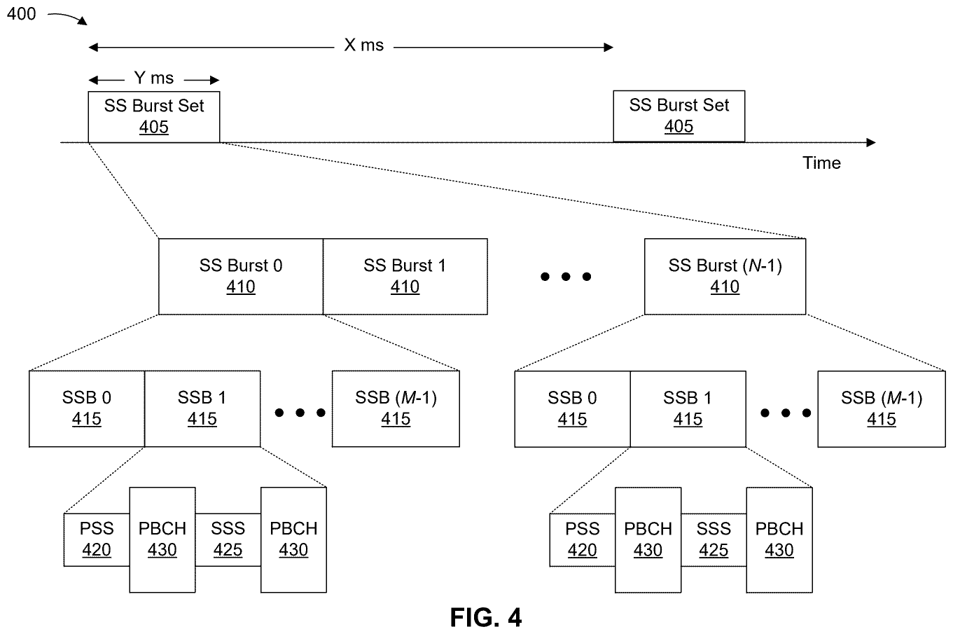

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SSBs 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds (ms), as shown in FIG. 4. In some aspects, an SS burst set 405 may have a fixed or dynamic length, shown as Y ms in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a PSS 420, an SSS 425, and/or a PBCH 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols). In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different Rx beams during an initial network access procedure and/or a cell search procedure, among other examples. Based at least in part on the monitoring and/or measuring, the UE 120 may indicate one or more SSBs 415 with a best signal parameter (e.g., an RSRP parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a RACH procedure). Additionally, or alternatively, the UE 120 may use the SSB 415 and/or the SSB index to determine a cell timing for a cell via which the SSB 415 is received (e.g., a serving cell).

As indicated above, FIG. 4 is provided as an example. Other examples may differ from what is described with regard to FIG. 4.

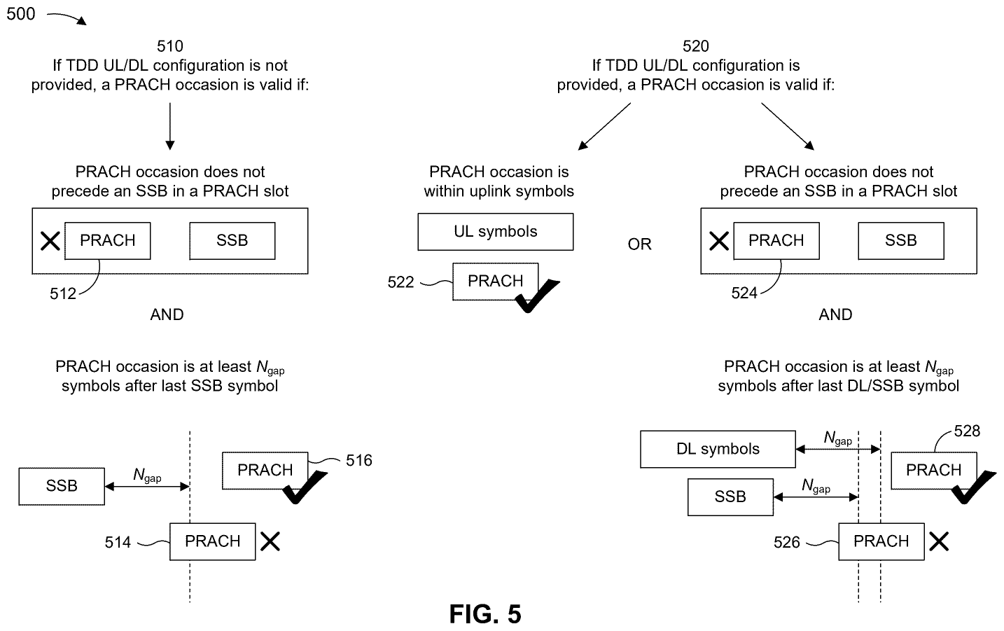

FIG. 5 is a diagram illustrating examples 500 of validation rules associated with a PRACH occasion, in accordance with the present disclosure. For example, from a physical layer perspective at a UE, a four-step RACH procedure, also known as a Type-1 random access procedure, includes transmission of a random access preamble (Msg1) in a valid PRACH occasion, reception of a random access response (RAR) message with a PDCCH/PDSCH (Msg2), and when applicable, transmission of a PUSCH scheduled by an uplink grant in the RAR (Msg3) and reception of a PDSCH for contention resolution (Msg4). Additionally, or alternatively, a two-step RACH procedure, also known as a Type-2 random access procedure, includes transmission of a random access preamble in a valid PRACH occasion and a PUSCH (MsgA) and reception of a RAR message with a PDCCH/PDSCH (MsgB), and when applicable, transmission of a PUSCH scheduled by a fallback uplink grant in the RAR and reception of a PDSCH for contention resolution. In either case, when a RACH procedure is triggered (e.g., by higher layers at the UE and/or by a PDCCH order message received from a network node), the UE may determine a PRACH occasion (e.g., corresponding to time and frequency resources for a PRACH transmission) in which to transmit the random access preamble according to an SSB-RO mapping.

For example, prior to initiation of a RACH procedure, a network node may provide a UE with random access configuration information that indicates PRACH transmission parameters (e.g., a PRACH preamble format, time/frequency resources for PRACH transmission, a preamble index, and/or a preamble subcarrier spacing (SCS), among other examples). Furthermore, the UE may receive an indication of one or more SSB indexes in an ssb-PositionslnBurst parameter (e.g., indicated in SIB1 and/or a ServingCellConfigCommon parameter) that are mapped to valid PRACH occasions. For example, the SSB indexes indicated in the ssb-PositionslnBurst parameter are mapped to valid PRACH occasions in an increasing order of preamble indexes within a single PRACH occasion, then in an increasing order of frequency resource indexes for frequency multiplexed PRACH occasions, then in an increasing order of time resource indexes for time multiplexed PRACH occasions within a PRACH slot, and then in an increasing order of indexes for PRACH slots. In this way, when a PRACH transmission is triggered at the UE, the UE may transmit a PRACH preamble in a valid PRACH occasion that is mapped to an SSB index (e.g., an SSB index indicated in a PDCCH order triggering the PRACH transmission or an SSB index selected by the UE). Accordingly, because the UE transmits the PRACH preamble in a valid PRACH occasion that is mapped to or otherwise associated with an SSB index, the UE may apply one or more validation rules to determine whether a PRACH occasion is valid or invalid. For example, in paired spectrum or a supplementary uplink band, all PRACH occasions are valid. However, for unpaired spectrum (e.g., a TDD band), a PRACH occasion must satisfy one or more validation rules to be considered valid.

For example, as shown in FIG. 5, the validation rules that are applied to determine whether a PRACH occasion is valid or invalid may depend on whether a UE has been provided with a parameter that indicates an uplink and downlink TDD configuration. For example, the uplink and downlink TDD configuration may be indicated in a tdd-UL-DL-ConfigurationCommon parameter, and may include a periodicity of a TDD pattern, a number of consecutive full downlink slots that begin each TDD pattern, a number of consecutive downlink symbols in the beginning of a slot that follows a last full downlink slot, a number of consecutive full uplink slots that end each TDD pattern, and a number of consecutive uplink symbols in the end of a slot that precedes a first full uplink slot. Accordingly, as described herein, the UE may apply a first set of validation rules to determine whether a PRACH occasion is valid in cases where the uplink and downlink TDD configuration has not been provided, and may apply a second set of validation rules to determine whether a PRACH occasion is valid in cases where the uplink and downlink TDD configuration has not been provided.

For example, as shown by reference number 510, if the UE has not been provided with an uplink and downlink TDD configuration, a PRACH occasion in a PRACH slot is valid if the PRACH occasion does not precede an SSB in the PRACH slot and starts at least N_{gap} symbols after a last SSB reception symbol, where N_{gap} may have a value that depends on a preamble SCS (e.g., N_{gap} may have a value of 0 for a preamble SCS of 1.25 kilohertz (kHz) or 5 kHz, 2 for a preamble SCS of 15 kHz, 30 kHz, 60 kHz, or 120 kHz, 8 for a preamble SCS of 480 kHz, or 16 for a preamble SCS of 960 kHz). Furthermore, in cases where a semi-static channel access mode is configured, a valid PRACH occasion cannot overlap with a set of consecutive symbols before the start of a next channel occupancy time where the UE does not transmit. Otherwise, a PRACH occasion that fails to satisfy the applicable validation rules is considered invalid for SSB-RO mapping purposes and for PRACH transmission. For example, FIG. 5 depicts a PRACH occasion 512 that is invalid because the PRACH occasion 512 precedes an SSB in the PRACH slot. Furthermore, FIG. 5 depicts a PRACH occasion 514 that is invalid because the PRACH occasion 514 is fewer than N_{gap} symbols after a last SSB reception symbol. On the other hand, a PRACH occasion 516 that does not precede an SSB in a PRACH slot and is at least N_{gap} symbols after a last SSB reception symbol is considered valid.

Additionally, or alternatively, as shown by reference number 520, if the UE has been provided with an uplink and downlink TDD configuration, a PRACH occasion is valid if the PRACH occasion is within uplink symbols. For example, FIG. 5 depicts a PRACH occasion 522 that is valid because PRACH occasion 522 is within uplink symbols. Alternatively, if a PRACH occasion is not within uplink symbols (e.g., is within downlink or flexible symbols), the PRACH occasion is valid if the PRACH occasion does not precede an SSB in a PRACH slot and starts at least N_{gap} symbols after a last downlink symbol and least N_{gap} symbols after a last SSB symbol, where N_{gap} may have a value that depends on a preamble SCS. Furthermore, in cases where a semi-static channel access mode is configured, a valid PRACH occasion cannot overlap with a set of consecutive symbols before the start of a next channel occupancy time where no transmissions are permitted. Otherwise, a PRACH occasion that fails to satisfy the applicable validation rules is considered invalid for SSB-RO mapping purposes and for PRACH transmission. For example, FIG. 5 depicts a PRACH occasion 524 that is invalid because the PRACH occasion 524 precedes an SSB in the PRACH slot. Furthermore, FIG. 5 depicts a PRACH occasion 526 that is invalid because the PRACH occasion 526 is fewer than N_{gap} symbols after a last downlink symbol and fewer than N_{gap} symbols after a last SSB symbol. On the other hand, a PRACH occasion 528 that does not precede an SSB in a PRACH slot and is at least N_{gap} symbols after a last downlink symbol and a last SSB reception symbol is considered valid.

As indicated above, FIG. 5 is provided as an example. Other examples may differ from what is described with regard to FIG. 5.

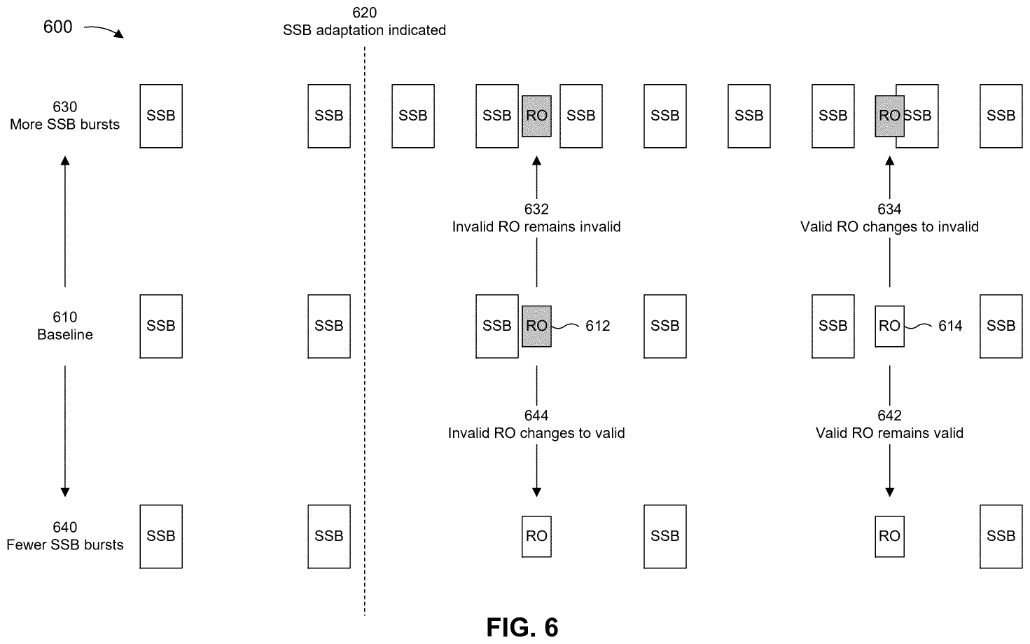

FIG. 6 is a diagram illustrating an example 600 of SSB adaptation in a time domain, in accordance with the present disclosure. For example, NES and/or network energy efficiency measures are expected to have increased importance in wireless network operations for various reasons, such as climate change mitigation, environmental sustainability, and/or network cost reduction, among other examples. For example, although 5G NR generally offers a significant energy efficiency improvement per gigabyte over previous generations, some NR use cases and/or the adoption of millimeter wave frequencies may require more network sites, more network antennas, larger bandwidths, and/or more frequency bands, among other examples, which may lead to more efficient wireless networks that nonetheless have higher energy requirements and/or cause more emissions than previous wireless network generations. Furthermore, energy accounts for a significant proportion of the cost to operate a wireless network. For example, according to some estimates, energy costs are about one-fourth of the total cost to operate a wireless network, and most of the energy consumption and/or energy costs are associated with a RAN, with data centers and fiber transport accounting for smaller shares. Accordingly, measures to increase network energy savings and/or improve network energy efficiency are factors that may drive adoption and/or expansion of wireless networks.

One technique to increase energy efficiency in a RAN is to enable dynamic or semi-static adaptation for an SSB in a time domain (e.g., adapting an SSB periodicity). For example, as described herein, a network node may periodically transmit an SSB that carries a PSS, an SSS, and/or a PBCH and to support initial access, cell search, cell measurement, cell selection or reselection, cell acquisition, camping, time and frequency synchronization, beam management, and/or beam selection, among other examples. Typically, the network node transmits the SSB following a periodic schedule where the SSB is transmitted one or more times, and often beamswept in multiple beam directions, in each SSB period or SSB burst. Therefore, one way to reduce power consumption in a RAN is to adapt the SSB periodicity such that the SSB is transmitted less frequently by a network node operating in an NES mode (or NES state) or more frequently during periods of high demand. However, dynamically or semi-statically adapting the SSB periodicity poses challenges, such as potentially causing a valid PRACH occasion to become invalid and/or causing an invalid PRACH occasion to become valid.

For example, as described herein, a PRACH occasion or RO generally includes resources in a time domain and a frequency domain in which a UE can transmit a PRACH preamble to initiate a RACH procedure. Furthermore, a UE may determine an SSB-RO mapping, where one or more SSB indexes are each mapped to a respective set of one or more valid PRACH occasions. In general, a PRACH occasion may be valid or invalid depending on whether the PRACH occasion satisfies a set of validation rules. Furthermore, in some cases, the set of validation rules that are applied to a particular PRACH occasion may include one or more validation rules that relate to an SSB timing. For example, in some case, a PRACH occasion may be valid if the PRACH occasion does not precede an SSB in a PRACH slot and starts at least a threshold number of symbols (e.g., N_{gap} symbols) after a last SSB symbol.

Accordingly, in some cases, a valid PRACH occasion that does not precede an SSB in a PRACH slot and starts at least the threshold number of symbols after a last SSB symbol may become invalid due to a decrease in an SSB periodicity (e.g., resulting in SSBs being transmitted more frequently) resulting in the PRACH occasion preceding an SSB in a PRACH slot and/or starting fewer than the threshold number of symbols after a last SSB symbol. For example, referring to FIG. 6, an SSB transmitted by a network node may have a baseline periodicity 610 (e.g., 20 ms). Accordingly, as shown in FIG. 6, an RO 612 is invalid because the RO 612 is fewer than N_{gap} symbols after a last SSB symbol and therefore fails to satisfy the applicable validation rules that relate to SSB timing. Alternatively, a valid RO 614 satisfies the applicable validation rules that relate to SSB timing, including that the RO 614 is at least N_{gap} symbols after a last SSB symbol and does not precede an SSB in a PRACH slot. However, after SSB adaptation (e.g., changing the SSB periodicity) is indicated, as shown by reference number 620, the validity or invalidity of one or more ROs may change.

For example, as shown by reference number 630, the SSB adaptation may indicate a decrease to the SSB periodicity (e.g., reducing the periodicity from 20 ms to 10 ms, such that more SSB bursts are transmitted). In this case, as shown by reference number 632, the RO 612 that is invalid under the baseline periodicity 610 remains invalid after the SSB periodicity is decreased, because the RO 612 is still fewer than N_{gap} symbols after a last SSB symbol. However, as shown by reference number 634, the RO 614 that was valid under the baseline periodicity 610 changes to invalid after the SSB periodicity is decreased, because the RO 614 precedes an SSB in a PRACH slot (shown by an overlap between the RO and an SSB). Alternatively, as shown by reference number 640, the SSB adaptation may indicate an increase to the SSB periodicity (e.g., increasing the SSB periodicity from 20 ms to 40 ms, such that fewer SSB bursts are transmitted). In this case, as shown by reference number 642, the RO 614 that is valid under the baseline periodicity 610 remains valid after the SSB periodicity is increased, because the RO 612 is still at least N_{gap} symbols after a last SSB symbol and does not precede an SSB in a PRACH slot. However, as shown by reference number 644, the RO 612 that was invalid under the baseline periodicity 610 changes to valid after the SSB periodicity is increased, because the RO 612 is more N_{gap} symbols after a last SSB symbol and does not precede an SSB in a PRACH slot when the SSB periodicity is increased.

Accordingly, when a change to an SSB periodicity is indicated, one or more ROs that were valid under a baseline SSB periodicity prior to the adaptation may change to invalid when the SSB periodicity is decreased, and one or more ROs that were invalid under the baseline SSB periodicity prior to the adaptation may change to valid when the SSB periodicity is increased. As a result, the change to the RO validity status may indicate an SSB-RO mapping (e.g., because an SSB index is generally mapped to a set of valid ROs), which can detrimentally impact a UE and/or disrupt legacy RACH operation. For example, although legacy RACH operation permits a network node to change an SSB periodicity, the change to the SSB periodicity can only be indicated via an update in SIB1. Accordingly, when SSB adaptation is supported, a UE may need to determine the applicable rules for determining whether an RO is valid or invalid under the new SSB periodicity, particularly when a valid RO changes to invalid and/or an invalid RO changes to valid.

Various aspects relate generally to a PRACH configuration under SSB adaptation in a time domain. Some aspects more specifically relate to a UE receiving, from a network node, an indication of a change to an SSB periodicity, where the change may increase an SSB periodicity such that SSBs are transmitted less frequently or decrease an SSB periodicity such that SSBs are transmitted more frequently. Accordingly, some aspects described herein relate to techniques to determine a validity for one or more PRACH occasions when the change to the SSB periodicity resulting in one or more valid PRACH occasions becoming invalid and/or one or more invalid PRACH occasions becoming valid. For example, when a valid PRACH occasion fails to satisfy one or more validation rules related to an SSB timing after the change to the SSB periodicity, the PRACH occasion may remain valid for SSB-RO mapping purposes only (e.g., a UE does not use the PRACH occasion to transmit a PRACH preamble). In this way, the change to the validity of the PRACH occasion does not change the SSB-RO mapping, and legacy operation is not disrupted because the PRACH occasion is not used for RACH transmission. Similarly, when an invalid PRACH occasion satisfies the one or more validation rules related to an SSB timing after the change to the SSB periodicity, the PRACH occasion may remain invalid, which also does not change the SSB-RO mapping or disrupt legacy RACH operation. In such cases, when the change to the SSB periodicity is reflected in a SIB, such as SIB1, the UE may then follow the one or more validation rules to determine whether PRACH occasions are valid or invalid. Alternatively, in some aspects, the UE may follow the one or more validation rules to determine whether PRACH occasions are valid or invalid when the indication of the change to the SSB periodicity is indicated, where the validation rules may apply to indicated SSBs in addition to SSB indexes indicated in a SIB and/or a serving cell configuration.

As indicated above, FIG. 6 is provided as an example. Other examples may differ from what is described with regard to FIG. 6.

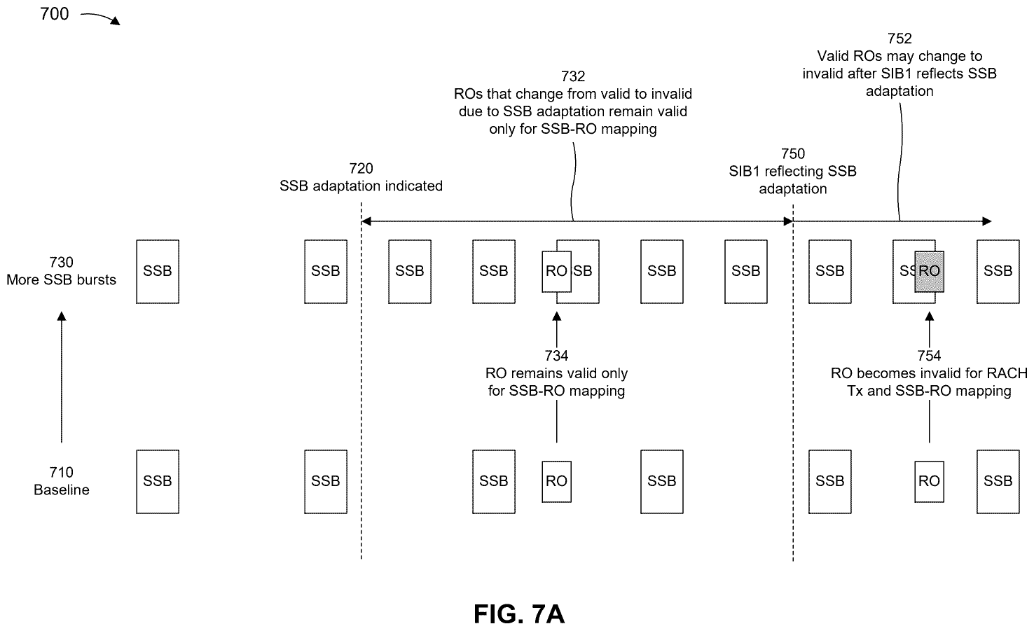

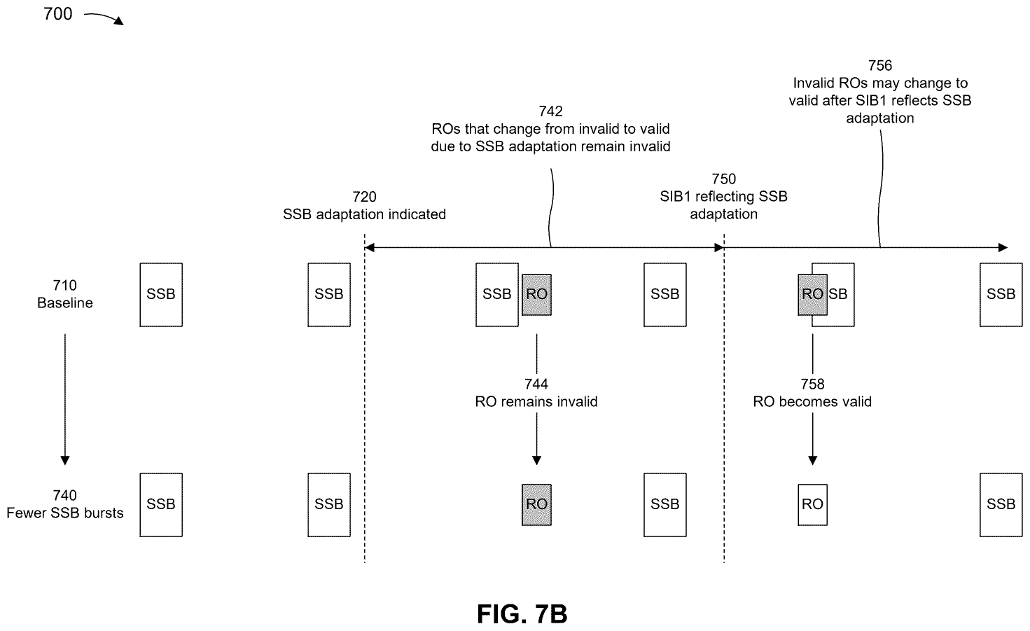

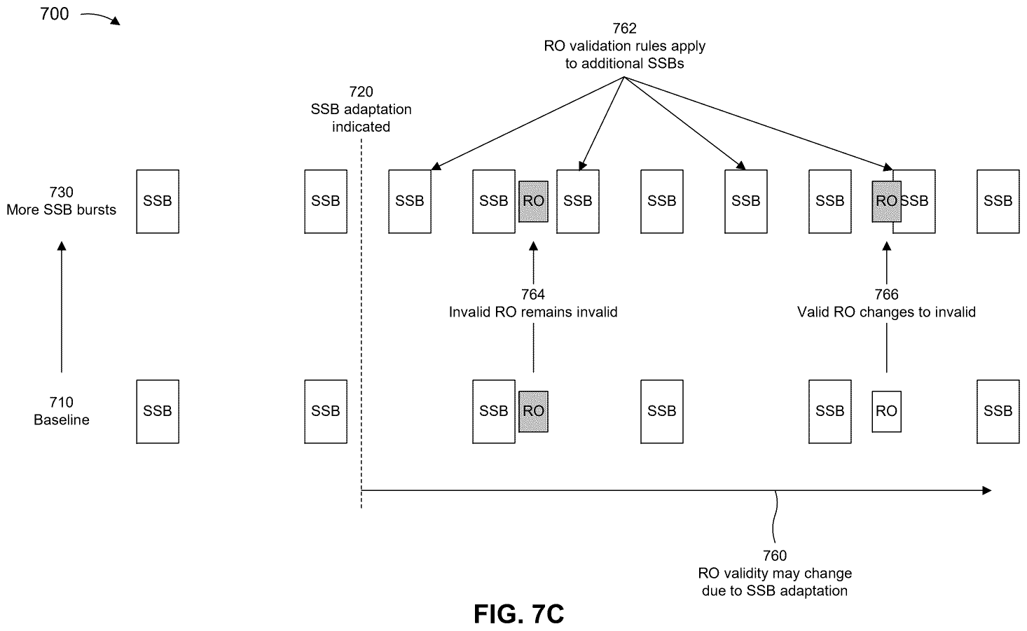

FIGS. 7A-7C are diagrams illustrating examples 700 associated with a PRACH configuration under SSB adaptation in a time domain, in accordance with the present disclosure. As described herein, examples 700 include communication between a network node (e.g., network node 110) and a UE (e.g., UE 120) in a wireless network, such as wireless network 100. The network node and the UE may communicate via a wireless access link, which may include an uplink and a downlink.

In some aspects, as described herein, the network node may periodically transmit one or more SSB bursts according to a baseline SSB periodicity 710, which may have a value of 5, 10, 20, 40, 80, or 160 ms. Furthermore, as described herein, the network node may transmit, and the UE may receive, an indication of one or more SSB indexes to be mapped to valid PRACH occasions such that the UE may determine an SSB-RO mapping to select a suitable RO in which to transmit a PRACH preamble when a RACH procedure is triggered at the UE. For example, in some aspects, one or more SSB indexes may be indicated in an ssb-PositionslnBurst parameter (e.g., in a SIB, such as SIB1, or an RRC parameter, such as ServingCellConfigCommon), and the one or more SSB indexes may be mapped to valid ROs first in an increasing order of preamble indexes within a single RO, second in an increasing order of frequency resource indexes for frequency multiplexed ROs, third in an increasing order of time resource indexes for time multiplexed RO within a PRACH slot, and fourth in an increasing order of indexes for PRACH slots. Accordingly, in order to map each of the one or more SSB indexes to an appropriate set of valid ROs, the UE may determine one or more valid ROs based at least in part on a set of validation rules that relate to an SSB timing.

For example, in unpaired spectrum, a PRACH occasion in a PRACH slot may satisfy the validation rules related to the SSB timing based at least in part on the PRACH occasion not preceding an SSB in a PRACH slot and starting at least N_{gap} symbols after a last SSB reception symbol, where N_{gap} has a value that depends on a preamble SCS. Additionally, or alternatively, in some cases, one or more other validation rules that are unrelated to an SSB timing may be applicable to a PRACH occasion depending on whether the UE has been provided with an uplink and downlink TDD configuration associated with the network node and/or depending on whether a semi-static channel access mode is configured. For example, if the UE has not been provided with an uplink and downlink TDD configuration associated with the network node and a semi-static channel access mode is configured, a PRACH occasion that satisfies the validation rules related to SSB timing is valid if the PRACH occasion does not overlap with a set of consecutive symbols before the start of a next channel occupancy time where the UE does not transmit. Additionally, or alternatively, if the UE has been provided with an uplink and downlink TDD configuration, a PRACH occasion that is within uplink symbols is valid regardless of whether the PRACH occasion satisfies the validation rules related to the SSB timing. However, if the UE has been provided with an uplink and downlink TDD configuration, a PRACH occasion that is not within uplink symbols and otherwise satisfies the validation rules related to the SSB timing is valid if the PRACH occasion is also at least N_{gap} symbols after a last downlink symbol. Additionally, or alternatively, if a semi-static channel access mode is configured, a valid PRACH occasion cannot overlap with a set of consecutive symbols before the start of a next channel occupancy time where no transmissions are permitted.

Accordingly, as described herein, there are various circumstances in which the validity or invalidity of an RO depends on whether the RO precedes an SSB in a PRACH slot and/or whether the RO starts at least N_{gap} symbols after a last SSB symbol. In such cases, when adaptation of an SSB periodicity is enabled, increasing or decreasing the SSB periodicity may result in a validity status of one or more ROs changing from valid to invalid or from invalid to invalid, which can impact an SSB-RO mapping. For example, as shown by reference number 720 in FIGS. 7A-7C, a UE may receive an indication of dynamic or semi-static SSB adaptation (e.g., in an RRC message, a MAC-CE, or a DCI message), where the indication of SSB adaptation may indicate a change to the SSB periodicity.

For example, as shown in FIG. 7A, the SSB adaptation may indicate a decreased SSB periodicity 730, which may result in more frequent SSB bursts. In such cases, because there are more SSB bursts under the decreased SSB periodicity 730, an RO that satisfied the validation rules related to SSB timing under the baseline SSB periodicity 710 may fail to satisfy one or more of the validation rules related to the SSB timing under the decreased SSB periodicity 730. For example, an RO that does not precede an SSB in a PRACH slot and starts at least N_{gap} symbols after a last SSB symbol under the baseline SSB periodicity 710 may precede an SSB in a PRACH slot or start fewer than N_{gap} symbols after a last SSB symbol under the decreased SSB periodicity 730. In such cases, as shown by reference number 732, an RO that changes from valid to invalid due to the SSB adaptation may remain valid even if the RO precedes an SSB in a PRACH slot or starts fewer than N_{gap} symbols after a last SSB symbol under the decreased SSB periodicity 730. In other words, an RO that was valid prior to the SSB adaptation in the time domain remains valid after the SSB adaptation. However, if the RO precedes an SSB in a PRACH slot or starts fewer than N_{gap} symbols after a last SSB symbol under the decreased SSB periodicity 730, the RO is valid only for SSB-RO mapping purposes, and the UE does not use the RO that fails to satisfy the validation rules related to SSB timing for PRACH transmission. For example, as shown by reference number 734 in FIG. 7A, an RO that does not precede an SSB block in a PRACH slot and starts at least N_{gap} symbols after a last SSB symbol under the baseline SSB periodicity 710 fails to satisfy the validation rules related to SSB timing under the decreased SSB periodicity 730 (e.g., due to preceding an SSB in a PRACH slot). Accordingly, because the RO was valid under the baseline SSB periodicity 710 before the SSB adaptation was indicated, the RO remains valid after the SSB adaptation, but only for an SSB-RO mapping.

Additionally, or alternatively, as shown in FIG. 7B, the SSB adaptation may indicate an increased SSB periodicity 740, which may result in fewer or less frequent SSB bursts. In such cases, because there are fewer SSB bursts under the increased SSB periodicity 740, an RO that failed to satisfy one or more validation rules related to SSB timing under the baseline SSB periodicity 710 may satisfy the validation rules related to the SSB timing under the increased SSB periodicity 740. For example, an RO that precedes an SSB in a PRACH slot and/or starts fewer than N_{gap} symbols after a last SSB symbol under the baseline SSB periodicity 710 may cease to precede an SSB in a PRACH slot and start at N_{gap} or more symbols after a last SSB symbol under the increased SSB periodicity 740. In such cases, as shown by reference number 742, an RO that changes from invalid to valid due to the SSB adaptation may remain invalid even if the RO does not precede an SSB in a PRACH slot and starts at least N_{gap} symbols after a last SSB symbol under the increased SSB periodicity 740. In other words, an RO that was invalid prior to the SSB adaptation in the time domain remains invalid after the SSB adaptation. In such cases, the RO is invalid for SSB-RO mapping purposes and the UE does not use the RO for PRACH transmission even though the RO satisfies the validation rules related to SSB timing under the increased SSB periodicity. For example, as shown by reference number 744 in FIG. 7B, an RO that starts fewer than N_{gap} symbols after a last SSB symbol under the baseline SSB periodicity 710 satisfies the validation rules related to SSB timing under the increased SSB periodicity 740 (e.g., due to the SSB that was fewer than N_{gap} symbols before the RO being dropped under the increased SSB periodicity 740). Accordingly, because the RO was invalid under the baseline SSB periodicity 710 before the SSB adaptation was indicated, the RO remains invalid after the SSB adaptation (e.g., the SSB adaptation does not impact an SSB-RO mapping).

In some aspects, as described herein, the SSB adaptation in the time domain may generally occur on a faster timeline than a SIB1 update. Accordingly, there may be scenarios where the SSB adaptation is indicated, as shown by reference number 720 in FIGS. 7A-7B, and the change to the SSB periodicity is then reflected in an update to SIB1, as shown by reference number 750 in FIGS. 7A-7B. In such cases, the validity of an RO after the SIB1 update may depend on whether the RO satisfies the validation rules related to SSB timing after the SIB1 update. For example, as shown by reference number 752 in FIG. 7A, one or more ROs that satisfied the applicable rules related to SSB timing under the baseline SSB periodicity 710, and were valid only for SSB-RO mapping purposes under the decreased SSB periodicity 730, may change to invalid after the SIB1 update reflects the decreased SSB periodicity 730. For example, as shown by reference number 754 in FIG. 7A, an RO that is valid under the baseline SSB periodicity 710 (e.g., does not precede an SSB block in a PRACH slot and starts at least N_{gap} symbols after a last SSB symbol) may become invalid after the updated SIB1 reflects the decreased SSB periodicity 730 (e.g., resulting in the RO starting fewer than N_{gap} symbols after a last SSB symbol). Furthermore, in this case, the RO becomes invalid for an SSB-RO mapping and for PRACH transmission after the decreased SSB periodicity 730 is reflected in the updated SIB1. Similarly, as shown by reference number 756 in FIG. 7B, one or more ROs that failed to satisfy the applicable rules related to SSB timing under the baseline SSB periodicity 710, and were therefore also invalid for SSB-RO mapping purposes and PRACH transmission under the increased SSB periodicity 740, may become valid after the SIB1 update reflects the decreased SSB periodicity 730. For example, as shown by reference number 758 in FIG. 7B, an RO that is invalid under the baseline SSB periodicity 710 (e.g., due to preceding an SSB block in a PRACH slot) may become valid after the updated SIB1 reflects the increased SSB periodicity 740 (e.g., resulting in the RO not preceding an SSB in a PRACH slot and starting at least N_{gap} symbols after a last SSB symbol). In this case, the RO becomes valid for an SSB-RO mapping and for PRACH transmission after the increased SSB periodicity 740 is reflected in the updated SIB1.

In some aspects, as shown by reference number 760 in FIG. 7C, the validity of an RO after the SSB adaptation may depend on whether the RO satisfies the validation rules related to SSB timing after the SSB adaptation. For example, as described herein, an RO may change after SSB adaption in a time domain is indicated (e.g., from valid to invalid when the SSB periodicity is decreased, resulting in more frequent SSB transmissions, or from invalid to valid when the SSB periodicity is increased, resulting in less frequent SSB transmissions). Furthermore, as shown by reference number 762 in FIG. 7C, the validation rules may be applicable to additional SSBs or additional SSB bursts that are transmitted after the SSB adaptation is indicated. For example, in some cases, the validation rules related to SSB timing may generally apply to SSBs associated with SSB indexes that are indicated in an ssb-PositionsInBurst parameter (e.g., in SIB1 and/or in a ServingCellConfigCommon parameter). Accordingly, as shown by reference number 762, the validation rules may additionally apply to SSB indexes associated with additional SSB bursts that are transmitted under a decreased SSB periodicity 730. For example, as shown by reference number 764, an RO that is fewer than N_{gap} symbols after a last SSB symbol under the baseline SSB periodicity 710 is also fewer than N_{gap} symbols after a last SSB symbol under the decreased SSB periodicity 730, whereby the invalid RO remains invalid after the SSB adaptation is indicated. However, as shown by reference number 766, a valid RO that does not precede an SSB in a PRACH slot and is at least N_{gap} symbols after a last SSB symbol under the baseline SSB periodicity 710 changes to invalid under the decreased SSB periodicity 730, because the RO precedes an SSB in a PRACH slot. Furthermore, although FIG. 7C indicates the applicability of the validation rules related to SSB timing after an SSB adaptation that results in more frequent SSB bursts, the same validation rules may apply after an SSB adaptation that results in less frequent SSB bursts (e.g., a previously invalid RO may become valid if the RO no longer precedes an SSB in a PRACH slot and is at least N_{gap} symbols after a last SSB symbol after the decrease in SSB periodicity results in less frequent SSB transmissions).

As indicated above, FIGS. 7A-7C is provided as an example. Other examples may differ from what is described with regard to FIGS. 7A-7C.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with a PRACH configuration under SSB adaptation in a time domain.

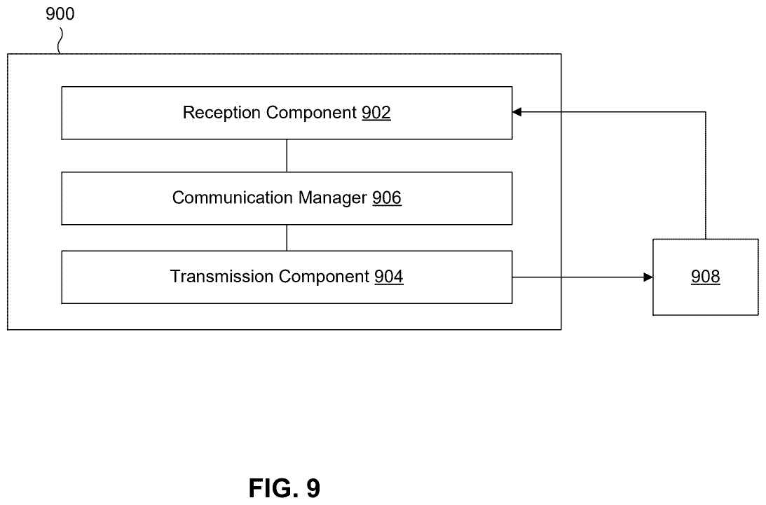

As shown in FIG. 8, in some aspects, process 800 may include receiving an indication associated with a change to an SSB periodicity (block 810). For example, the UE (e.g., using reception component 902 and/or communication manager 906, depicted in FIG. 9) may receive an indication associated with a change to an SSB periodicity, as described above.

As further shown in FIG. 8, in some aspects, process 800 may include determining one or more valid PRACH occasions based at least in part on the change to the SSB periodicity (block 820). For example, the UE (e.g., using communication manager 906, depicted in FIG. 9) may determine one or more valid PRACH occasions based at least in part on the change to the SSB periodicity, as described above.

As further shown in FIG. 8, in some aspects, process 800 may include mapping at least one SSB index to the one or more valid PRACH occasions (block 830). For example, the UE (e.g., using communication manager 906, depicted in FIG. 9) may mapping at least one SSB index to the one or more valid PRACH occasions, as described above.

Process 800 may include additional aspects, such as any single aspect or any combination of aspects described below and/or in connection with one or more other processes described elsewhere herein.

In a first aspect, a validity associated with a PRACH occasion after the change to the SSB periodicity is based at least in part on whether the PRACH occasion satisfied one or more validation rules related to an SSB timing before the change to the SSB periodicity.

In a second aspect, alone or in combination with the first aspect, the PRACH occasion is valid after the change to the SSB periodicity based at least in part on the PRACH occasion satisfying the one or more validation rules before the change to the SSB periodicity.

In a third aspect, alone or in combination with one or more of the first and second aspects, the PRACH occasion is unavailable for transmitting a PRACH preamble based at least in part on the PRACH occasion failing to satisfy the one or more validation rules after the change to the SSB periodicity.

In a fourth aspect, alone or in combination with one or more of the first through third aspects, the PRACH occasion is invalid after the change to the SSB periodicity based at least in part on the PRACH occasion failing to satisfy the one or more validation rules before the change to the SSB periodicity.

In a fifth aspect, alone or in combination with one or more of the first through fourth aspects, process 800 includes receiving a SIB that reflects the change to the SSB periodicity, wherein the validity associated with the PRACH occasion after receiving the SIB is based at least in part on whether the PRACH occasion satisfies the one or more validation rules related to the SSB timing after receiving the SIB.

In a sixth aspect, alone or in combination with one or more of the first through fifth aspects, a validity associated with a PRACH occasion after the change to the SSB periodicity is based at least in part on whether the PRACH occasion satisfies one or more validation rules related to an SSB timing after the change to the SSB periodicity.

In a seventh aspect, alone or in combination with one or more of the first through sixth aspects, the one or more validation rules related to the SSB timing are applicable to one or more additional SSB transmissions resulting from the change decreasing to the SSB periodicity.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE, or a UE may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 140 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 7A-7C. Additionally, or alternatively, the apparatus 900 may be configured to perform one or more processes described herein, such as process 800 of FIG. 8. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 904 may be co-located with the reception component 902 in one or more transceivers.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The reception component 902 may receive an indication associated with a change to an SSB periodicity. The communication manager 906 may determine one or more valid PRACH occasions based at least in part on the change to the SSB periodicity. The communication manager 906 may mapping at least one SSB index to the one or more valid PRACH occasions.

The reception component 902 may receive a SIB that reflects the change to the SSB periodicity, wherein the validity associated with the PRACH occasion after receiving the SIB is based at least in part on whether the PRACH occasion satisfies the one or more validation rules related to the SSB timing after receiving the SIB.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

The following provides an overview of some Aspects of the present disclosure:

Aspect 1: A method of wireless communication performed by a UE, comprising: receiving an indication associated with a change to an SSB periodicity; determining one or more valid PRACH occasions based at least in part on the change to the SSB periodicity; and mapping at least one SSB index to the one or more valid PRACH occasions.

Aspect 2: The method of Aspect 1, wherein a validity associated with a PRACH occasion after the change to the SSB periodicity is based at least in part on whether the PRACH occasion satisfied one or more validation rules related to an SSB timing before the change to the SSB periodicity.

Aspect 3: The method of Aspect 2, wherein the PRACH occasion is valid after the change to the SSB periodicity based at least in part on the PRACH occasion satisfying the one or more validation rules before the change to the SSB periodicity.

Aspect 4: The method of Aspect 3, wherein the PRACH occasion is unavailable for transmitting a PRACH preamble based at least in part on the PRACH occasion failing to satisfy the one or more validation rules after the change to the SSB periodicity.

Aspect 5: The method of Aspect 2, wherein the PRACH occasion is invalid after the change to the SSB periodicity based at least in part on the PRACH occasion failing to satisfy the one or more validation rules before the change to the SSB periodicity.

Aspect 6: The method of Aspect 2, further comprising: receiving a SIB that reflects the change to the SSB periodicity, wherein the validity associated with the PRACH occasion after receiving the SIB is based at least in part on whether the PRACH occasion satisfies the one or more validation rules related to the SSB timing after receiving the SIB.

Aspect 7: The method of any of Aspects 1-6, wherein a validity associated with a PRACH occasion after the change to the SSB periodicity is based at least in part on whether the PRACH occasion satisfies one or more validation rules related to an SSB timing after the change to the SSB periodicity.

Aspect 8: The method of Aspect 7, wherein the one or more validation rules related to the SSB timing are applicable to one or more additional SSB transmissions resulting from the change decreasing to the SSB periodicity.

Aspect 9: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-8.

Aspect 10: An apparatus for wireless communication at a device, the apparatus comprising one or more memories and one or more processors coupled to the one or more memories, the one or more processors configured to cause the device to perform the method of one or more of Aspects 1-8.

Aspect 11: An apparatus for wireless communication, the apparatus comprising at least one means for performing the method of one or more of Aspects 1-8.

Aspect 12: A non-transitory computer-readable medium storing code for wireless communication, the code comprising instructions executable by one or more processors to perform the method of one or more of Aspects 1-8.

Aspect 13: A non-transitory computer-readable medium storing a set of instructions for wireless communication, the set of instructions comprising one or more instructions that, when executed by one or more processors of a device, cause the device to perform the method of one or more of Aspects 1-8.

Aspect 14: A device for wireless communication, the device comprising a processing system that includes one or more processors and one or more memories coupled with the one or more processors, the processing system configured to cause the device to perform the method of one or more of Aspects 1-8.

Aspect 15: An apparatus for wireless communication at a device, the apparatus comprising one or more memories and one or more processors coupled to the one or more memories, the one or more processors individually or collectively configured to cause the device to perform the method of one or more of Aspects 1-8.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware, firmware, or a combination of hardware and software. As used herein, a processor is implemented in hardware, firmware, or a combination of hardware and software. As used herein, the phrase “based on” is intended to be broadly construed to mean “based at least in part on.” As used herein, “satisfying a threshold” may, depending on the context, refer to a value being greater than the threshold, greater than or equal to the threshold, less than the threshold, less than or equal to the threshold, equal to the threshold, or not equal to the threshold, among other examples. As used herein, a phrase referring to “at least one of” a list of items refers to any combination of those items, including single members. As an example, “at least one of: a, b, or c is intended to cover: a, b, c, a+b, a+c, b+c, and a+b+c.

Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (for example, related items, unrelated items, or a combination of related and unrelated items), and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A also may have B). Further, as used herein, the term “or” is intended to be inclusive when used in a series and may be used interchangeably with “and/or,” unless explicitly stated otherwise (for example, if used in combination with “either” or “only one of”).

The various illustrative logics, logical blocks, modules, circuits and algorithm processes described in connection with the aspects disclosed herein may be implemented as electronic hardware, computer software, or combinations of both. The interchangeability of hardware and software has been described generally, in terms of functionality, and illustrated in the various illustrative components, blocks, modules, circuits and processes described herein. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. A processor also may be implemented as a combination of computing devices, for example, a combination of a DSP and a microprocessor, a plurality of microprocessors, one or more microprocessors in conjunction with a DSP core, or any other such configuration. In some aspects, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Aspects of the subject matter described in this specification also can be implemented as one or more computer programs (such as one or more modules of computer program instructions) encoded on a computer storage media for execution by, or to control the operation of, a data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the media described herein should also be included within the scope of computer-readable media. Additionally, the operations of a method or algorithm may reside as one or any combination or set of codes and instructions on a machine readable medium and computer-readable medium, which may be incorporated into a computer program product.

Various modifications to the aspects described in this disclosure may be readily apparent to those skilled in the art, and the generic principles defined herein may be applied to other aspects without departing from the spirit or scope of this disclosure. Thus, the claims are not intended to be limited to the aspects shown herein, but are to be accorded the widest scope consistent with this disclosure, the principles and the novel features disclosed herein.

Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of any device as implemented.

Certain features that are described in this specification in the context of separate aspects also can be implemented in combination in a single aspect. Conversely, various features that are described in the context of a single aspect also can be implemented in multiple aspects separately or in any suitable subcombination. Moreover, although features may be described as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the aspects described should not be understood as requiring such separation in all aspects, and it should be understood that the described program components and systems can generally be integrated together in a single software product or packaged into multiple software products. Additionally, other aspects are within the scope of the following claims. In some cases, the actions recited in the claims can be performed in a different order and still achieve desirable results.

What is claimed is:

1. A method of wireless communication performed by a user equipment (UE), comprising:
receiving an indication associated with a change to a synchronization signal block (SSB) periodicity;
determining one or more valid physical random access channel (PRACH) occasions based at least in part on the change to the SSB periodicity; and
mapping at least one SSB index to the one or more valid PRACH occasions.

2. The method of claim 1, wherein a validity associated with a PRACH occasion after the change to the SSB periodicity is based at least in part on whether the PRACH occasion satisfied one or more validation rules related to an SSB timing before the change to the SSB periodicity.

3. The method of claim 2, wherein the PRACH occasion is valid after the change to the SSB periodicity based at least in part on the PRACH occasion satisfying the one or more validation rules before the change to the SSB periodicity.

4. The method of claim 3, wherein the PRACH occasion is unavailable for transmitting a PRACH preamble based at least in part on the PRACH occasion failing to satisfy the one or more validation rules after the change to the SSB periodicity.

5. The method of claim 2, wherein the PRACH occasion is invalid after the change to the SSB periodicity based at least in part on the PRACH occasion failing to satisfy the one or more validation rules before the change to the SSB periodicity.

6. The method of claim 2, further comprising:
receiving a system information block (SIB) that reflects the change to the SSB periodicity, wherein the validity associated with the PRACH occasion after receiving the SIB is based at least in part on whether the PRACH occasion satisfies the one or more validation rules related to the SSB timing after receiving the SIB.

7. The method of claim 1, wherein a validity associated with a PRACH occasion after the change to the SSB periodicity is based at least in part on whether the PRACH occasion satisfies one or more validation rules related to an SSB timing after the change to the SSB periodicity.

8. The method of claim 7, wherein the one or more validation rules related to the SSB timing are applicable to one or more additional SSB transmissions resulting from the change decreasing to the SSB periodicity.

9. A user equipment (UE) for wireless communication, comprising:
one or more memories; and
one or more processors, coupled to the one or more memories, configured to cause the UE to:
receive an indication associated with a change to a synchronization signal block (SSB) periodicity;
determine one or more valid physical random access channel (PRACH) occasions based at least in part on the change to the SSB periodicity; and
mapping at least one SSB index to the one or more valid PRACH occasions.

10. The UE of claim 9, wherein a validity associated with a PRACH occasion after the change to the SSB periodicity is based at least in part on whether the PRACH occasion satisfied one or more validation rules related to an SSB timing before the change to the SSB periodicity.

11. The UE of claim 10, wherein the PRACH occasion is valid after the change to the SSB periodicity based at least in part on the PRACH occasion satisfying the one or more validation rules before the change to the SSB periodicity.

12. The UE of claim 11, wherein the PRACH occasion is unavailable for transmitting a PRACH preamble based at least in part on the PRACH occasion failing to satisfy the one or more validation rules after the change to the SSB periodicity.

13. The UE of claim 10, wherein the PRACH occasion is invalid after the change to the SSB periodicity based at least in part on the PRACH occasion failing to satisfy the one or more validation rules before the change to the SSB periodicity.

14. The UE of claim 10, wherein the one or more processors are further configured to cause the UE to:
receive a system information block (SIB) that reflects the change to the SSB periodicity, wherein the validity associated with the PRACH occasion after receiving the SIB is based at least in part on whether the PRACH occasion satisfies the one or more validation rules related to the SSB timing after receiving the SIB.

15. The UE of claim 9, wherein a validity associated with a PRACH occasion after the change to the SSB periodicity is based at least in part on whether the PRACH occasion satisfies one or more validation rules related to an SSB timing after the change to the SSB periodicity.

16. The UE of claim 15, wherein the one or more validation rules related to the SSB timing are applicable to one or more additional SSB transmissions resulting from the change decreasing to the SSB periodicity.

17. A non-transitory computer-readable medium storing a set of instructions for wireless communication, the set of instructions comprising:
one or more instructions that, when executed by one or more processors of a user equipment (UE), cause the UE to:
receive an indication associated with a change to a synchronization signal block (SSB) periodicity;
determine one or more valid physical random access channel (PRACH) occasions based at least in part on the change to the SSB periodicity; and
mapping at least one SSB index to the one or more valid PRACH occasions.

18. The non-transitory computer-readable medium of claim 17, wherein a validity associated with a PRACH occasion after the change to the SSB periodicity is based at least in part on whether the PRACH occasion satisfied one or more validation rules related to an SSB timing before the change to the SSB periodicity.

19. The non-transitory computer-readable medium of claim 18, wherein the one or more instructions further cause the UE to:
receive a system information block (SIB) that reflects the change to the SSB periodicity, wherein the validity associated with the PRACH occasion after receiving the SIB is based at least in part on whether the PRACH occasion satisfies the one or more validation rules related to the SSB timing after receiving the SIB.

20. The non-transitory computer-readable medium of claim 17, wherein a validity associated with a PRACH occasion after the change to the SSB periodicity is based at least in part on whether the PRACH occasion satisfies one or more validation rules related to an SSB timing after the change to the SSB periodicity.
